(19) United States
(12) Patent Application Publication
(10) Pub. No.: US 2021/0292660 A1
(43) Pub. Date: Sep. 23, 2021

(54) PROCESS INTEGRATION BETWEEN HNCC AND CRUDE OIL ATMOSPHERIC DISTILLATION COLUMN

(71) Applicant: SABIC Global Technologies B.V., Bergen op Zoom (NL)

(72) Inventors: Talal AL-SHAMMARI, Riyadh (SA); Sekhar Babu MAMILLA, Geleen (NL)

(21) Appl. No.: 17/260,166

(22) PCT Filed: Jun. 5, 2019
(86) PCT No.: PCT/IB2019/054692

§ 371 Date: Jan. 13, 2021

Related U.S. Application Data
(60) Provisional application No. 62/711,417, filed on Jul. 27, 2018.

(51) Int. Cl. C10G 51/04; B01D 3/14

(52) U.S. Cl. CPC C10G 51/04; B01D 3/14; C10G 2300/301; C10G 2300/4012; C10G 2400/30; C10G 2300/4006; C10G 2400/20

(57) ABSTRACT

Systems and methods for processing crude oil and producing light olefins and BTX are disclosed. Crude oil is distilled in an atmospheric distillation column to produce a gas stream, a light naphtha stream, a heavy naphtha stream, a fuel oil stream and a refinery feed stream. Heavy naphtha stream is then fed to a heavy naphtha catalytic cracker to produce a cracked stream. The cracked stream is further processed to produce a lights stream, a heavies stream, and a stream comprising olefins and BTX. The lights stream is combined with the light naphtha stream and fed to a steam cracker to produce additional light olefins. Heavies stream is recycled back to the heavy naphtha catalytic cracker.

### CROSS REFERENCE TO RELATED APPLICATIONS

This application claims the benefit of priority of U.S. Provisional Patent Application No. 62/711,417, filed Jul. 27, 2018, which is hereby incorporated by reference in its entirety.

### FIELD OF INVENTION

The present invention generally relates to methods of processing crude oil. More specifically, the present invention relates to a method of processing crude oil in an atmospheric distillation unit to produce light naphtha and heavy naphtha that are steam cracked and catalytically cracked, respectively.

### BACKGROUND OF THE INVENTION

Light olefins (C₂ to C₄ olefins) are building blocks for many chemical processes. Light olefins are used to produce polyethylene, polypropylene, ethylene oxide, ethylene chloride, propylene oxide, and acrylic acid, which, in turn, are used in a wide variety of industries such as the plastic processing, construction, textile, and automotive industries. Generally, light olefins are produced by steam cracking naphtha and dehydrogenation of paraffin.

BTX (benzene, toluene, and xylene) are a group aromatics that are used in many different areas of chemical industry, especially the plastic and polymer sectors. For instance, benzene is a precursor for producing polystyrene, phenolic resins, polycarbonate, and nylon. Toluene is used for producing polyurethane and as a gasoline component. Xylene is feedstock for producing polyester fibers and phthalic anhydride. In the petrochemical industry, benzene, toluene, and xylene are conventionally produced by catalytic reforming of naphtha.

Over the last few decades, the demand for both light olefins and BTX has been consistently increasing. The conventional methods of producing light olefins and BTX may not meet the market demand for these chemicals. Heavy naphtha catalytic cracking (HNCC) is a process that consumes hydrocarbon mixture with boiling point less than 250° C. to produce light olefins and BTX. However, the feedstock for this process is not easily obtainable. Furthermore, the production efficiency for a HNCC process is relatively low.

Overall, while methods of producing light olefins and BTX exist, the need for improvements in this field persists in light of at least the aforementioned drawbacks for the methods.

### BRIEF SUMMARY OF THE INVENTION

A solution to at least some of the above-mentioned problems associated with the production process for light olefins and BTX has been discovered. The solution resides in a method of processing crude oil that includes a distillation process to produce a heavy naphtha stream and catalytically cracking the heavy naphtha stream to produce a cracked stream that comprises light olefins and BTX. This can be beneficial for at least improving the availability of the feedstock for producing light olefins and BTX via heavy naphtha catalytic cracking. Notably, this method integrates steam cracking with heavy naphtha catalytic cracking to produce additional light olefins, resulting in improved production efficiency for light olefins and BTX. Therefore, the methods of the present invention provide a technical solution over at least some of the problems associated with the currently available methods for producing light olefins and BTX mentioned above.

Embodiments of the invention include a method of processing crude oil. The method comprises feeding the crude oil to an atmospheric distillation column, the crude oil having an initial boiling point (IBP) of −45 to −1° C. and a final boiling point (FBP) of 270 to 310° C. The method further comprises distilling the crude oil in the atmospheric distillation column to produce a plurality of streams that include a heavy naphtha stream having an IBP of 40 to 60° C. and a FBP of 200 to 270° C. The method further still comprises catalytically cracking the heavy naphtha stream to produce a cracked stream. The method further comprises processing the cracked stream to produce C₂ to C₄ olefins, benzene, toluene, and xylene.

Embodiments of the invention include a method of processing crude oil. The method comprises feeding the crude oil to an atmospheric distillation column, the crude oil having an initial boiling point (IBP) of −45 to −1° C. and a final boiling point (FBP) of 270 to 310° C. The method further comprises distilling the crude oil in the atmospheric distillation column to produce a plurality of streams that include a heavy naphtha stream having an IBP of 40 to 60° C. and a FBP of 200 to 270° C. The method further comprises catalytically cracking the heavy naphtha stream to produce a cracked stream. The method further still comprises processing the cracked stream to produce C₂ to C₄ olefins, benzene, toluene, and xylene. The method further comprises steam cracking the light naphtha stream to produce olefins.

Embodiments of the invention include a method of processing crude oil. The method comprises feeding the crude oil to an atmospheric distillation column, the crude oil having an initial boiling point (IBP) of −45 to −1° C. and a final boiling point (FBP) of 270 to 310° C. The method further comprises distilling the crude oil in the atmospheric distillation column to produce a plurality of streams that include a heavy naphtha stream having an IBP of 40 to 60° C. and a FBP of 200 to 270° C. The method further still comprises catalytically cracking the heavy naphtha stream to produce a cracked stream. The method further comprises processing the cracked stream to produce a stream comprising primarily C₂ to C₄ olefins, benzene, toluene, xylene, collectively, a lights stream comprising primarily C₂ to C₄ hydrocarbons, and a heavies stream comprising C₅ to C₁₂ hydrocarbons. The method further still comprises combining the light naphtha stream with the lights stream to form a combined lights stream. The method further comprises steam cracking the combined lights stream to produce olefins.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a system of processing crude oil, according to embodiments of the invention; and

FIG. 2 shows a schematic flowchart of a method of processing crude oil according to embodiments of the invention.

### DETAILED DESCRIPTION OF THE INVENTION

Currently, light olefins can be produced by steam cracking light naphtha. BTX can be produced by catalytic reforming of naphtha. As demand for certain chemicals increases, other routes of producing these two groups of chemicals are desired. Heavy naphtha catalytic cracking (HNCC) is capable of producing both light olefins and BTX. However, the quantity of feedstock for heavy naphtha catalytic cracking is limited. Furthermore, the production efficiency for heavy naphtha catalytic cracking is relatively low due to limited usage of the process streams other than the product stream from heavy naphtha catalytic cracking process. The present invention provides a solution to at least one of the problems. The solution is premised on a method including directly processing crude oil to produce feedstocks for heavy naphtha catalytic cracking. This method further utilizes byproduct streams produced in the olefins and BTX production process to produce additional light olefins, resulting in improved production efficiency. These and other non-limiting aspects of the present invention are discussed in further detail in the following sections.

### A. System for Processing Crude Oil and Producing Olefins and BTX

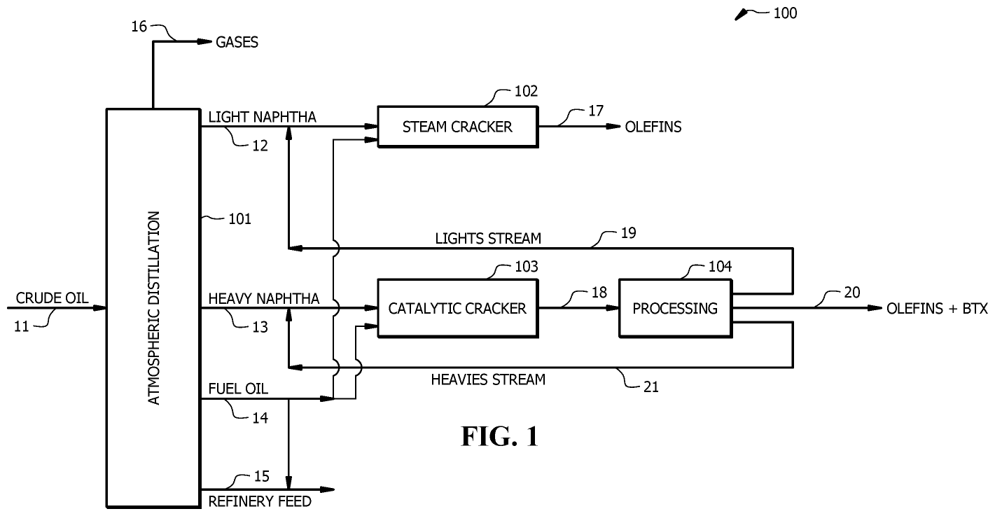

In embodiments of the invention, the system for processing crude oil and producing olefins and BTX can include an integrated system for separating and processing different fractions of crude oil. With reference to FIG. 1, a schematic diagram is shown of system 100 that is capable of directly processing crude oil to produce light olefins (C₂ and C₃ olefins) and BTX (benzene, toluene, xylene) with improved production efficiency compared to conventional heavy naphtha catalytic cracking process. According to embodiments of the invention, system 100 includes distillation unit 101 configured to distill crude oil (stream 11) to form light naphtha stream 12, heavy naphtha stream 13, fuel oil stream 14, refinery feed stream 15, and gas stream 16. In embodiments of the invention, distillation unit 101 may comprise an atmospheric distillation column. The crude oil may comprise light crude oil.

In embodiments of the invention, distillation unit 101 may include a first outlet in fluid communication with a gas processing unit such that gas stream 16 flows from distillation unit 101 to the gas processing unit. According to embodiments of the invention, distillation unit 101 may include a second outlet in fluid communication with steam cracker 102 such that light naphtha stream 12 flows from distillation unit 101 to steam cracker 102. In embodiments of the invention, steam cracker 102 may be configured to crack at least a portion of light naphtha of light naphtha stream 12 to form stream 17 comprising olefins.

According to embodiments of the invention, distillation unit 101 may further include a third outlet in fluid communication with an inlet of heavy naphtha catalytic cracker 103 such that heavy naphtha stream 13 flows from distillation unit 101 to heavy naphtha catalytic cracker 103. In embodiments of the invention, heavy naphtha catalytic cracker 103 may be configured to react heavy naphtha stream 13 in presence of a catalyst to produce cracked stream 18 comprising BTX or, olefins. In embodiments of the invention, an outlet of heavy naphtha catalytic cracker 103 may be in fluid communication with processing unit 104 such that cracked stream 18 flows from heavy naphtha catalytic cracker 103 to processing unit 104.

In embodiments of the invention, processing unit 104 may be configured to separate cracked stream 18 into lights stream 19, olefins and BTX stream 20, and heavies stream 21. According to embodiments of the invention, processing unit 104 may include a first outlet in fluid communication with an inlet of steam cracker 102 such that lights stream 19 flows from processing unit 104 to steam cracker 102. In embodiments of the invention, processing unit 104 may comprise a second outlet in fluid communication with an inlet of heavy naphtha catalytic cracker 103 such that heavies stream 21 is recycled from processing unit 104 back to heavy naphtha catalytic cracker 103.

In embodiments of the invention, processing unit 104 may further include a third outlet configured to release olefins and BTX stream 20 there from. In embodiments of the invention, the third outlet of processing unit 104 may be in fluid communication with a first separation unit configured to separate olefins and BTX stream 20 into a light olefins stream, a benzene stream, a toluene stream, a xylene stream, and a stream comprising C₄⁺ olefins.

### B. Methods of Processing Crude Oil and Producing Olefins and BTX

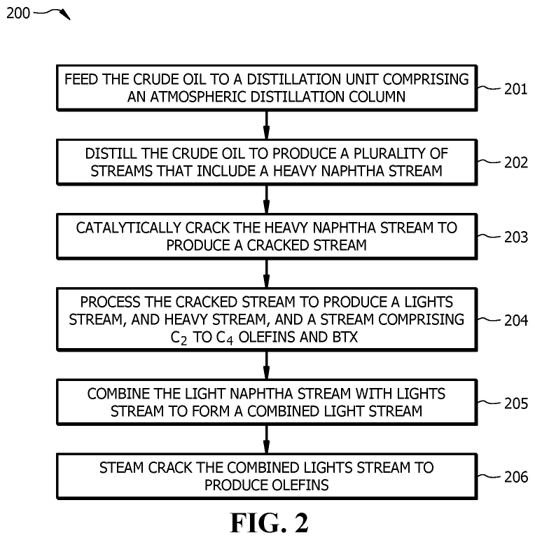

Methods of processing crude oil and producing olefins and BTX have been discovered to expand the feedstock for heavy naphtha catalytic cracker 103 and improve the production efficiency of the heavy naphtha catalytic cracker 103. As shown in FIG. 2, embodiments of the invention include method 200 for processing crude oil. Method 200 may be implemented by system 100, as shown in FIG. 1. According to embodiments of the invention, as shown in block 201, method 200 may include feeding the crude oil (stream 11) to distillation unit 101. In embodiments of the invention, the crude oil is light crude oil. The crude oil may have an initial boiling point (IBP) of −45 to −1° C. and a final boiling point (FBP) of 270 to 310° C. In embodiments, the distillation unit 101 may comprise an atmospheric distillation column.

Method 200 may further include distilling the crude oil in distillation unit 101 to produce a plurality of streams that include heavy naphtha stream 13, as shown in block 202. Heavy naphtha stream 13 may have an IBP of 40 to 60° C. and a FBP of 270 to 310° C. In embodiments of then invention, the plurality of streams may further include light naphtha stream 12 comprising primarily C₂ to C₆ hydrocarbons. Light naphtha stream 12 may have a IBP of 20 to 40° C. and a FBP of 90 to 100° C. In embodiments of the invention, the plurality of streams may further include gas stream 16. Gas stream 16 may include H₂, CH₄, off gases, or combinations thereof. In embodiments of the invention, gas stream 16 may be further treated in a gas processing unit.

In embodiments of the invention, the plurality of streams produced in block 202 may further include fuel oil stream 14 comprising hydrocarbons heavier than gasoline and naphtha, and refinery feed stream 15. Fuel oil stream 14 may be further separated to form a fuel oil light stream, a fuel oil heavy stream and a residual fuel oil stream. In embodiments of the invention, the fuel oil light stream may include light naphtha. The fuel oil heavy stream may include heavy naphtha.

In embodiments of the invention, the distilling at block 202 may be performed at an operating temperature in a range of −10 to 400° C. and all ranges and values there between including ranges of −10 to 0° C., 0 to 20° C., 20 to 40° C., 40 to 60° C., 60 to 80° C., 80 to 100° C., 0 to 20° C., 20 to 40° C., 40 to 60° C., 60 to 80° C., 80 to 100° C., 100 to 120° C., 120 to 140° C., 140 to 160° C., 160 to 180° C., 180 to 200° C., 200 to 220° C., 220 to 240° C., 240 to 260° C., 260 to 280° C., 280 to 300° C., 300 to 320° C., 320 to 340° C., 340 to 360° C., 360 to 380° C., and 380 to 400° C. The distilling at block 201 may be performed at an operating pressure of 1 to 3 bar and all ranges and values there between including 1.1 bar, 1.2 bar, 1.3 bar, 1.4 bar, 1.5 bar, 1.6 bar, 1.7 bar, 1.8 bar, 1.9 bar, 2.0 bar, 2.1 bar, 2.2 bar, 2.3 bar, 2.4 bar, 2.5 bar, 2.6 bar, 2.7 bar, 2.8 bar, and 2.9 bar.

In embodiments of the invention, method 200 may further include catalytically cracking heavy naphtha stream 13 to produce cracked stream 18, as shown in block 203. In embodiments of the invention, the catalytically cracking is performed under a reaction temperature in a range of 600 to 750° C. and all ranges and values there between including 600 to 610° C., 610 to 620° C., 620 to 630° C., 630 to 640° C., 640 to 650° C., 650 to 660° C., 660 to 670° C., 670 to 680° C., 680 to 690° C., 690 to 700° C., 700 to 710° C., 710 to 720° C., 720 to 730° C., 730 to 740° C., 740 to 750° C. In embodiments of the invention, the catalyst used in the catalytically cracking at block 203 may include H-ZSM-5 molecular sieve, metals, or combinations thereof.

According to embodiments of the invention, method 200 may further include processing cracked stream 18 to produce olefin and BTX stream comprising C₂ to C₄ olefins, benzene, toluene, and xylene, as shown in block 204. In embodiments of the invention, the processing at block 204 may include catalytic cracking, catalytic reforming, thermal cracking, or combinations thereof. In embodiments of the invention, the processing in block 204 may further produce lights stream 19 comprising primarily C₂ to C₄ hydrocarbons. In embodiments of the invention, the processing in block 204 may further produce heavies stream 21 comprising primarily C₅ to C₁₂ hydrocarbons.

In embodiments of the invention, method 200 may further include combining light naphtha stream 12 with lights stream 19 to form a combined lights stream, as shown in block 205. Method 200 may further still include steam cracking, in steam cracker 102, the combined lights stream to produce stream 17 comprising olefins, as shown in block 206. In embodiments of the invention, steam cracking in block 205 may be performed at a cracking temperature of 800 to 900° C. and all ranges and values there between including ranges of 800 to 805° C., 805 to 810° C., 810 to 815° C., 815 to 820° C., 820 to 825° C., 825 to 830° C., 830 to 835° C., 835 to 840° C., 840 to 845° C., 845 to 850° C., 850 to 855° C., 855 to 860° C., 860 to 865° C., 865 to 870° C., 870 to 875° C., 875 to 880° C., 880 to 885° C., 885 to 890° C., 890 to 895° C., and 895 to 900° C. In embodiments of the invention, steam cracker 102 may have a residence time of 1 to 100 ms at block 205 and all ranges and values there between including ranges of 1 to 5 ms, 5 to 10 ms, 10 to 20 ms, 20 to 30 ms, 30 to 40 ms, 40 to 50 ms, 50 to 60 ms, 60 to 70 ms, 70 to 80 ms, 80 to 90 ms, and 90 to 100 ms.

According to embodiments of the invention, method 200 may further still include recycling heavies stream 21 to heavy naphtha catalytic cracker 103. In embodiments of the invention, stream 17 comprising olefins may be further separated to produce light olefins including C₂ and C₃ olefins. In embodiments of the invention, the fuel oil light stream from fuel oil stream may be combined with light naphtha stream 12 and/or lights stream 19 and flowed to steam cracker 102. The fuel oil heavy stream from fuel oil stream 14 may be flowed to heavy naphtha catalytic cracker 103. The residual fuel oil stream may be combined with refinery feed stream 15.

Although embodiments of the present invention have been described with reference to blocks of FIG. 2, it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

In the context of the present invention, embodiments 1 through 14 are described. Embodiment 1 is a method of processing crude oil. The method includes feeding the crude oil to an atmospheric distillation column, the crude oil having an initial boiling point (IBP) of −45 to −1° C. and a final boiling point (FBP) of 270 to 310° C. The method also includes distilling the crude oil in the atmospheric distillation column to produce a plurality of streams that include a heavy naphtha stream having an IBP of 40 to 60° C. and a FBP of 200 to 270° C. The method further includes catalytically cracking the heavy naphtha stream to produce a cracked stream and processing the cracked stream to produce C₂ to C₄ olefins, benzene, toluene, and xylene. Embodiment 2 is the method of embodiment 1, wherein the distilling further produces a light naphtha stream having an IBP of 20 to 40° C. and a FBP of 90 to 100° C. Embodiment 3 is the method of embodiment 2, further including steam cracking the light naphtha stream to produce olefins. Embodiment 4 is the method of embodiment 2, wherein the processing further produces a lights stream containing primarily C₂ to C₄ hydrocarbons, and a heavies stream containing primarily C₅ to C₁₂ hydrocarbons. Embodiment 5 is the method of embodiment 4, further including combining the light naphtha stream with the lights stream to form a combined lights stream, and steam cracking the combined lights stream to produce olefins. Embodiment 6 is the method of embodiment 5, wherein the steam cracking is performed under process conditions including a cracking temperature of 800 to 900° C. and a residence time of 1 to 100 ms. Embodiment 7 is the method of any of embodiments 4 to 6, further including combining the heavies stream and the heavy naphtha stream to form a combined heavies stream, and catalytically cracking the combined heavies stream. Embodiment 8 is the method of any of embodiments 1 to 7, wherein the distilling is carried out at an operating temperature in a range of −10 to 400° C. Embodiment 9 is the method of any of embodiments 1 to 8, wherein the distilling is carried out at an operating pressure in a range of 1 to 3 bar. Embodiment 10 is the method of any of embodiments 1 to 9, wherein the catalytically cracking is performed under an operating temperature of 600 to 750° C. Embodiment 11 is the method of any of embodiments 1 to 10, wherein catalytically cracking is performed in the presence of a catalyst selected from the group consisting of H-ZSM-5 molecular sieve, metals, and combinations thereof. Embodiment 12 is the method of any of embodiments 1 to 11, wherein the processing of the cracked stream includes catalytic cracking, catalytic reforming, thermal cracking, or combinations thereof. Embodiment 13 is the method of any of embodiments 1 to 12, wherein the plurality of streams produced by the distilling of the crude oil further include a gas stream that contains H₂, CH₄, off gases, or combinations thereof.

Embodiment 14 is a method of processing crude oil. The method includes feeding the crude oil to an atmospheric distillation column the crude oil having an initial boiling point (IBP) of −40 to −1° C. and a final boiling point (FBP) of 270 to 310° C. The method also includes distilling the crude oil in the atmospheric distillation column to produce a plurality of streams that include a heavy naphtha stream having an IBP of 40 to 60° C. and a FBP of 200 to 270° C. and a light naphtha stream having an IBP of 20 to 40° C. and a FBP of 60 to 70° C. The method further includes catalytically cracking the heavy naphtha stream to produce a cracked stream and processing the cracked stream to produce a stream containing primarily C₂ to C₄ olefins, benzene, toluene, xylene, collectively, a lights stream containing primarily C₂ to C₄ hydrocarbons, and a heavies stream containing primarily C₅ to C₁₂ hydrocarbons. In addition, the method includes combining the light naphtha stream with the lights stream to form a combined lights stream, and steam cracking the combined lights stream to produce olefins.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of processing crude oil, the method comprising:
feeding the crude oil to an atmospheric distillation column, the crude oil having an initial boiling point (IBP) of −45 to −1° C. and a final boiling point (FBP) of 270 to 310° C.;
distilling the crude oil in the atmospheric distillation column to produce a plurality of streams that include a heavy naphtha stream having an IBP of 40 to 60° C. and a FBP of 200 to 270° C.;
catalytically cracking the heavy naphtha stream to produce a cracked stream;
processing the cracked stream to produce C₂ to C₄ olefins, benzene, toluene, and xylene.

2. The method of claim 1, wherein the distilling further produces a light naphtha stream having an IBP of 20 to 40° C. and a FBP of 90 to 100° C.

3. The method of claim 2, further comprising steam cracking the light naphtha stream to produce olefins.

4. The method of claim 2, wherein the processing further produces a lights stream comprising primarily C₂ to C₄ hydrocarbons, and a heavies stream comprising primarily C₅ to C₁₂ hydrocarbons.

5. The method of claim 4, further comprising:
combining the light naphtha stream with the lights stream to form a combined lights stream; and
steam cracking the combined lights stream to produce olefins.

6. The method of claim 5, wherein the steam cracking is performed under process conditions including a cracking temperature of 800 to 900° C. and a residence time of 1 to 100 ms.

7. The method of claim 4, further comprising:
combining the heavies stream and the heavy naphtha stream to form a combined heavies stream; and
catalytically cracking the combined heavies stream.

8. The method of claim 1, wherein the distilling is carried out at an operating temperature in a range of −10 to 400° C.

9. The method of claim 1, wherein the distilling is carried out at an operating pressure in a range of 1 to 3 bar.

10. The method of claim 1, wherein the catalytically cracking is performed under an operating temperature of 600 to 750° C.

11. The method of claim 1, wherein catalytically cracking is performed in the presence of a catalyst selected from the group consisting of H-ZSM-5 molecular sieve, metals, and combinations thereof.

12. The method of claim 1, wherein the processing of the cracked stream comprises catalytic cracking, catalytic reforming, thermal cracking, or combinations thereof.

13. The method of claim 1, wherein the plurality of streams produced by the distilling of the crude oil further include a gas stream that comprises H₂, CH₄, off gases, or combinations thereof.

14. A method of processing crude oil, the method comprising:
feeding the crude oil to an atmospheric distillation column the crude oil having an initial boiling point (IBP) of −40 to −1° C. and a final boiling point (FBP) of 270 to 310° C.;
distilling the crude oil in the atmospheric distillation column to produce a plurality of streams that include a heavy naphtha stream having an IBP of 40 to 60° C. and a FBP of 200 to 270° C. and a light naphtha stream having an IBP of 20 to 40° C. and a FBP of 60 to 70° C.;
catalytically cracking the heavy naphtha stream to produce a cracked stream;
processing the cracked stream to produce a stream comprising primarily C₂ to C₄ olefins, benzene, toluene, xylene, collectively, a lights stream comprising primarily C₂ to C₄ hydrocarbons, and a heavies stream comprising primarily C₅ to C₁₂ hydrocarbons;
combining the light naphtha stream with the lights stream to form a combined lights stream;
steam cracking the combined lights stream to produce olefins.

15. The method of claim 2, wherein the plurality of streams produced by the distilling of the crude oil further include a gas stream that comprises H₂, CH₄, off gases, or combinations thereof.

16. The method of claim 3, wherein the plurality of streams produced by the distilling of the crude oil further include a gas stream that comprises H₂, CH₄, off gases, or combinations thereof.

17. The method of claim 4, wherein the plurality of streams produced by the distilling of the crude oil further include a gas stream that comprises H₂, CH₄, off gases, or combinations thereof.

18. The method of claim 5, wherein the plurality of streams produced by the distilling of the crude oil further include a gas stream that comprises H₂, CH₄, off gases, or combinations thereof.

19. The method of claim 6, wherein the plurality of streams produced by the distilling of the crude oil further include a gas stream that comprises H₂, CH₄, off gases, or combinations thereof.

20. The method of claim 3, wherein the distilling is carried out at an operating temperature of −10° C.
